(19) United States
(12) Patent Application Publication
(10) Pub. No.: US 2007/0185284 A1
(43) Pub. Date: Aug. 9, 2007

(54) Polyester resin composition and the cable made thereit

(75) Inventors: Jung Bin Ok, Seoul (KR); Myeong Jin Ahn, Seoul (KR)

Correspondence Address: AKERMAN SENTERFITT, P.O. BOX 3188, WEST PALM BEACH, FL, 33402-3188, US

(73) Assignee: LG Cable Ltd., Seoul (KR)

(21) Appl. No.: 11/570,185

(22) PCT Filed: Jun. 9, 2004
(86) PCT No.: PCT/KR04/01373

§ 371 Date: Dec. 7, 2006

(51) Int. Cl. C08F 283/04

(52) U.S. Cl. 525/425

(57) ABSTRACT

The present invention discloses A polyester resin composition comprising: (a) a first resin component containing a copolymer of a polyester component with a lactone component, and (b) a second resin component containing a polyester resin, wherein the content of the first resin component in the composition is 30-70% based on the total weight the composition. Also, the invention discloses a cable comprising a conductor and at least one insulation layer covered around the conductor, wherein the insulation layer is made of the polyester resin composition. The inventive polyester resin composition is easily introduced with additives, has a significantly reduced possibility of hydrolysis and thus an improved thermal resistance, shows a wide elastic region, and is excellent in processability, impact resistance, thermal resistance and oil resistance

### TECHNICAL FIELD

The present invention relates to a polyester resin composition and a cable including an insulation layer made thereof, and more particularly to a polyester resin composition prepared by copolymerizing a polyester component with a lactone resin without simply mixing them and then blending the copolymer resin with a polyester resin, as well as a cable including an insulation layer made thereof.

### BACKGROUND ART

Generally, polyester resins, particularly polyethylene terephthalate and polybutylene terephthalate, are excellent in mechanical properties, thermal resistance, chemical resistance, safety and recycling possibility, and their properties or processability can be easily changed by modifying monomers used for their production. Also, their raw materials is easily available, their production process is relatively simple, and their cost-to-performance ratio is very high, and thus, such resins have been widely used in various applications. Recently, owing to their excellent electrical properties, these polyester resins are also frequently used in electronic parts or cables.

Particularly, polybutylene terephthalate among the polyester resins has two more methylene moieties in its structure than those of polyethylene terephthalate, and thus more flexible. Also, it has a low glass transition temperature of about 25° C. so that it shows rapid crystallization as compared to polyethylene terephthalate with a relatively higher glass transition temperature. Thus, polybutylene terephthalate is recently frequently used in the engineering plastic field. Also, in order to increase its thermal resistance or oxidation resistance by the addition of a variety of additives and to overcome the shortcoming of low impact resistance, methods of preparing a blend with flexible resin are frequently used.

Meanwhile, the production of thermoplastic elastomers using polyester resins is also widely used, and the thermoplastic elastomers contain both a crystalline moiety with rigidity and an amorphous moiety with elasticity in a molecule so that they realize various physical properties depending on the ratio of the two moieties. Since a crystal of a polyester moiety in such thermoplastic elastomers acts as a physical crosslinking point, the thermoplastic elastomers show an elastomer-like behavior at ambient temperature, but when they are heated to a higher temperature than the melting point of the crystal, their melt-processing becomes possible. It is generally known that an increase in the ratio of the amorphous moiety leads to increases in elasticity and flexibility but reductions in moldability, mechanical strength, dimensional stability and oil resistance.

In the use of such polyester resins, in order to improve the physical properties of the polyester resins and to make materials meeting the desired purpose, the technology in which the polyester resin is mixed with other resins, to which a flame retardant and an antioxidant are added, is widely used. Also, the technology of using compounds to make various products, particularly cables, by a general process such as injection or extrusion, is being proposed.

Namely, when the polyester resin is applied in actual processes for the production of products, a compound will be produced by adding various resins and additives to the polyester resin in order to improve physical properties and to reduce costs. In the production of such a compound, if polyester resin such as polyethylene terephthalate is used alone, the application of various additives for the improvement of flame-retardant, anti-oxidative and processing properties will be limited, and even if they are applied, they will highly reduce the properties of the resin, thus making the resin unsuitable for the desired purpose. Furthermore, even if a given amount of other resins such as polyolefin or thermoplastic elastomer are added to the polyester resin, they will result in a sharp reduction in compatibility or a reduction in physical properties and also will limit the use of various additives.

Accordingly, in one attempt to overcome such problems and particularly to impart flexibility to the polyester resin and increase the processability of the polyester resin while maintaining the physical properties of the polyester resin, the technology of adding a lactone resin with good compatibility to the polyester resin is disclosed in some literatures.

As the lactone resin, TONE commercially available from Dow Chemical Company and COPA commercially available from Solvay are mainly used. It is known that the lactone resin has low toxicity, makes processing in extrusion and injection easy, is highly compatible with other resins, and contributes to the mixing and dispersion of additives. Particularly, polylactone is flexible, has low melting point and is easily mixed with other resins, and thus, it is frequently used for the improvement of physical properties.

Studies on the improvement of physical properties of the polyester resins using such lactones are, for example, as follows.

U.S. Pat. No. 3,835,089 and EP No. 57,415A disclose introducing an inorganic additive such as phosphite into a blend of polybutylene terephthalate with polycaprolactone.

Also, U.S. Pat. No. 5,248,713 discloses introducing carbodiimide and phosphite into a blend of polybutylene terephthalate with polycaprolactone. A composition disclosed in this patent comprises at least 30%, based on the weight of the composition, of polybutylene terephthalate, at least 3% of polycaprolactone, about 0.05-10% of carbodiimide and about 0.05-10% of aliphatic phosphite.

Meanwhile, U.S. Pat. No. 5,660,932 discloses adding magnesium hydroxide to a blend of polybutylene terephthalate and a polyetherimide-siloxane compolymer, based on Limiting Oxygen Index (LOI). As the more recent technology, U.S. Pat. No. 5,824,412 discloses a blend of polybutylene terephthalate, a grafting agent, an ethylene copolymer and a thermoplastic elastomer.

According to such a prior art, if the lactone resin is added, it is blended and mixed with the polyester resin and/or the thermoplastic elastomer, a third component, or other resins, to make a blend to which a flame retardant and an antioxidant are then added. Meanwhile, to overcome the problem of hydrolysis tendency of the polyester resin, a hydrolysis-preventing agent such as carbodiimide is added at a given amount.

However, the temperature required for the melt-processing of the polyester resin is in a range of more than 200° C., whereas the polylactone is found to be melted at 60° C. Thus, in preparing a blend using various resins, a great difference in suitable processing temperature between the resins causes a problem making the processing difficult. Furthermore, since a resin with low processing temperature is applied with excessive heat, problems in either physical properties or blending and mixing can be caused. Also, even if the processing is made by this method, a negative result in a viewpoint of long-term use will be caused.

The possibility of occurrence of such problems can also be expected by a thermal analysis method such as DSC. Namely, it can be found that, when a process of heating the blend above a temperature where the polyester resin is completely melted and then cooling the heated blend below room temperature is repeated several times, the peak of the leacone resin on a graph will gradually decrease regardless of cooling conditions and finally almost disappear. This indicates that the excessive heat causes the degradation and/or property's change of the lactone resin, and in actual applications, leads to a reduction in various physical properties, such as tensile strength and elongation.

Moreover, in the case of a resin composition produced by making a blend of the polyester resin and a small amount of other resins and then adding a flame retardant and the like to the blend, even if physical properties at ambient temperature are realized, the resin composition has a problem in that, after thermal resistance tests, it shows a sharp deterioration in physical properties due to the inherent hydrolysis tendency of the polyester resin.

In other words, owing to the structural characteristics of the polyester, the resin composition tends to be hydrolyzed in an acidic or basic environment, and an increase in temperature makes hydrolytic reaction rate very fast. Also, metal hydroxide which is frequently used as a flame retardant catalyzes the hydrolytic reaction. As a result, polyester resin-based compositions including the simple blend of the lactone and the polyester have the problem of a very low thermal resistance even if a hydrolysis-preventing agent is used.

### DISCLOSURE OF INVENTION

Accordingly, the present invention has been made to solve the above-described problems occurring in the prior art, and it is an object of the present invention to provide a polyester resin composition which is easily added introduced with additives, shows a wide elastic region, is excellent in processability, impact resistance and oil resistance, shows no reduction in thermal resistance and can eliminate the deterioration of physical properties in long-term use, as well as a cable including an insulation layer made thereof.

To achieve the above object, in one aspect, the present invention provides a polyester resin composition comprising: (a) a first resin component containing a copolymer of a polyester component with a lactone component, and (b) a second resin component containing a polyester resin, wherein the content of the first resin component in the composition is 30-70% based on the total weight of the composition.

In the inventive polyester resin composition, the content of the first resin component is preferably greater than that of the second resin component. Also, the polyester in the first resin component is preferably polybutylene terephthalate, and the polyester resin in the second resin component is preferably polybutylene terephthalate. The lactone is preferably caprolactone, and the polyester resin composition preferably further comprises magnesium hydroxide in an amount of 10-40% based on the total weight of the resin composition, in which case the polyester resin composition preferably further comprises an antioxidant and polycarbodiimide in an amount of less than 10% based on the total weight of the resin composition.

In another aspect, the present invention provides a cable comprising a conductor and at least one insulation layer covered around the conductor, wherein the insulation layer is made of the above-described polyester resin composition.

The inventive cable preferably has two insulation layers consisting of an outer layer and an inner layer, wherein the outer or inner insulation layer is made of the above-described polyester resin composition.

Hereinafter, the polyester resin composition according to the present invention will be described in detail.

In order to overcome various problems occurring on the application of the prior polyester resin compositions, the present invention proposes a method in which a copolymer resin of a polyester component with a lactone component is used as a main component, a polyester resin is mixed with the copolymer resin, and various additives are added to the mixture. Furthermore, the present invention examines and proposes a suitable mixing ratio between the copolymer resin and the polyester resin, at which the thermal resistance of the composition can be secured.

Namely, the polyester resin composition according to the present invention comprises the first resin component comprising the copolymer resin of the polyester component with the lactone component, and the second resin component comprising the polyester resin, in which the content of the first resin component in the resin composition is 30-70% based on the total weight of the resin composition. To the blend of the first and second resin components, various additives are added.

First, in the copolymer resin of the polyester component with the lactone component, which is used as the first resin component, polyethylene terephthalate or polybutylene terephthalate, for example, is used as the polyester component, and gamma-caprolactone or polycaprolactone, for example, is used as the lactone component.

The content of the lactone component in the copolymer resin is preferably 10-60% weight and preferably 15-45% by weight based on the total weight of the resin composition. A change in the content of the lactone or polyester resin component in the copolymer resin can cause a change in physical properties. If the content of the lactone component is two high or too low, the thermal resistance of the composition will be reduced or an improvement in physical properties such as flexibility will not be made. The use of the copolymer resin of the polyester component with the lactone component provides advantages in that the composition is excellent in thermal resistance, weather resistance and chemical resistance and easily processed, as compared to the prior composition comprising a simple blend of a polyester resin and a lactone resin. Also, even if the content of the lactone component is changed in a given range, the melting point of the copolymer resin will be maintained at more than 200° C. Thus, the copolymer resin is easily blended and mixed with other resins. On the other hand, the application of the prior blending method causes problems in that, since the melting points of the polyester resin and the polylactone resin are more than 200° C. and about 60° C., respectively, which are greatly different from each other, their processing is very difficult, and particularly excessive heat is applied to the polylactone resin in a processing procedure. This severe thermal history causes not only a short-term reduction in physical properties but also negative results in a viewpoint of long-term use.

Furthermore, in view of thermal resistance and the like, the content of the copolymer resin as the first component in the resin composition is 30-70% and preferably 35-60%, as demonstrated in Examples below. This is because if the content of the copolymer resin is too low, the thermal resistance of the composition will show a tendency to decrease, and if the content is too high, the mechanical properties and electrical insulation resistance of the composition will show a tendency to decrease.

At this time, it is preferable that the content of the copolymer resin as the first component should be higher than the content of the polyester resin as the second component, since doing so can realize excellent physical properties in terms of thermal resistance.

The polyester resin in the second component fundamentally comprises polyethylene terephthalate (PET) or polybutylene terephthalate, and also comprises a resin having modified molecular weight or viscosity for the improvement of physical properties and poor characteristics. Moreover, the second component may also comprise polytetramethylene terephthalate (PTMT), polycyclohexylenedimethyl terephthalate (PCT) and polyethylene naphthalate (PEN).

The content of the polyester resin as the second component is preferably 5-60% and more preferably 10-50%, based on the weight of the resin composition. A change in the content of the polyester resin causes a change in physical properties together with the copolymer resin as the first component.

The present invention suitably uses a flame retardant to secure flame retardancy, an antioxidant to improve thermal stability and antioxidative characteristics, a hydrolysis-preventing agent to overcome a hydrolysis tendency which is common in polyester resins, as well as a multifunctional acrylic resin to control flowability.

First, as the flame retardant which is used in the present invention, metal hydroxide, melamine and phosphorous can be used alone or in combination in view of synergistic effects. The content of the flame retardant in the resin composition is preferably 5-45% and more preferably 10-40%, based on the total weight of the resin composition. Particularly, since the use of the metal hydroxide flame retardant can cause a hydrolytic reaction which is an inherent shortcoming of the polyester resins, its excessive use can cause a sharp reduction in mechanical properties and the like.

As the antioxidant, butylphenyl phosphite, hydroxyphenyl propionate, hydroxyphenyl propionamide, hydroxybenzyl triazine, pentaerytritol diphosphite and the like can be used alone or in combination in order to enhance thermal resistance and antioxidative characteristics. In view of the enhancement of thermal resistance and antioxidative characteristics, the content of the antioxidant in the resin composition is preferably 1-10% based on the total weight of the resin composition, and the use of a excessive or too small amount of the antioxidant causes negative effects on the improvement of physical properties.

The hydrolysis-preventing agent is an additive of inhibiting the occurrence of a hydrolytic reaction by isolating the terminal portions of polyester where the hydrolysis occurs. As the hydrolysis-preventing agent, a material such as aromatic carbodiimide can be used. In the present invention, the hydrolysis is significantly inhibited by the use of the copolymer resin as the first component, and if necessary, polycarbodiimide as the hydrolysis-preventing agent may be used in an amount of 0-5% based on the total weight of the resin composition. Such a hydrolysis-preventing agent is very expensive and also does not result in an improvement in physical properties even if it is used in higher amounts than a suitable amount.

Meanwhile, if the polyester resin is considered to have excessive flowability due to high melt flow index, a multifunctional acrylic resin to which a functional group such as epoxy is linked may be added to control the flowability suitably. Such a multifunctional acrylic resin is preferably used in an amount of 0-5% based on the total weight of the resin composition. Since this multifunctional acrylic resin generally has a low melting point of about 100° C., it needs to be used in a suitable amount in view of thermal resistance.

In the inventive resin composition, the copolymer resin of the polyester component with the lactone resin is used as a main component and mixed with the polyester resin, in which the copolymer resin is used in a suitable amount confirmed by the present invention. Thus, in the inventive resin composition, additives is easily introduced and the possibility of hydrolysis is greatly reduced so as to significantly improve thermal resistance, as compared to the prior art of adding other components to the polyester resin as a main component by simple blending. Particularly, the use of the copolymer of the polyester component with the lactone component can eliminate the possibilities of a reduction in thermal resistance and deterioration in physical properties in long-term use, which occur in the case where the polyester component and the lactone resin are simply mixed with each other.

In the copolymer resin of the polyester component copolymerized with the polyester component, polyethylene terephthalate or polybutylene terephthalate, for example, is used as the polyester component, and gamma-caprolactone or polycaprolactone, for example, is used as the lactone component. Thus, the inventive resin composition shows a wide elastic region, and is excellent in processability, impact resistance, thermal resistance and oil resistance.

Hereinafter, a cable including the inventive resin composition will be described in detail.

The polyester resin composition prepared as described above can be used in various applications by a processing method such as injection or extrusion, in which case mechanical properties, chemical resistance, thermal resistance and the like are secured.

In the present invention, the polyester resin composition is applied in the production of a cable. Namely, the inventive cable comprises a conductor and one or two or more insulation layers, in which the inventive polyester resin composition is covered around the conductor or at least one of the insulation layers by an extrusion process, so that at least one of the insulation layers covered around the conductor is made of the inventive polyester resin composition.

Particularly if the cable comprises two insulation layers consisting of an outer layer and an inner layer, the outer insulation layer may be made of the polyester resin composition, and the inner insulation layer may be made of the inventive polyester composition. Alternatively, the outer insulation layer may be made of the inventive polyester resin composition, and the inner insulation layer may be made of the prior polyester resin composition.

### BEST MODE FOR CARRYING OUT THE INVENTION

Hereinafter, the present will be described in further detail by the following examples. It is to be understood, however, that the present invention is not limited to or by the examples, and various changes, variations or modifications to these examples can be made in the scope of the present invention as claimed in the appended claims. The following examples are given to provide a full and complete disclosure of the present invention, and at the same time, to provide a better understanding of the present invention to a person skilled in the art.

### Examples

The inventive polyester resin compositions were prepared in three Examples while changing their formulation, and resin compositions for the comparison of physical properties with the inventive polyester resin compositions were prepared in three Comparative Examples.

Table 1 below shows the formulation of the composition according to each of Examples and Comparative Examples.

TABLE 1

| | | | | Comparative | Comparative | Comparative |
|---|---|---|---|---|---|---|
| | Example 1 | Example 2 | Example 3 | Example 1 | Example 2 | Example 3 |
| Component | (wt %) | (wt %) | (wt %) | (wt %) | (wt %) | (wt %) |
| Polyester- | 45 | 32 | 58 | — | 10 | 22 |
| lactone | | | | | | |
| copolymer | | | | | | |
| resin | | | | | | |
| Polyester | — | — | — | 24 | — | — |
| thermoplastic | | | | | | |
| elastomer | | | | | | |
| Polyester resin | 28 | 41 | 14 | 56 | 70 | 58 |
| Metal | 22 | 20 | 22 | 15 | 15 | 15 |
| hydroxide | | | | | | |
| flame retardant | | | | | | |
| Melamine | — | 2 | — | — | — | — |
| flame retardant | | | | | | |
| Antioxidant | 3 | 3 | 3 | 3 | 3 | 3 |
| Hydrolysis- | 2 | 2 | 2 | 2 | 2 | 2 |
| preventing | | | | | | |
| agent | | | | | | |
| Multifunctional | — | — | 1 | — | — | — |
| resin | | | | | | |

The components contained in each of Examples and Comparative Examples were blended and mixed using an apparatus such as an internal mixer at a temperature of 230-250° C. for 15 minutes. The sample of each of Examples and Comparative Examples was tested for tensile strength, elongation and oil resistance.

Mechanical properties at ambient temperature were tested according to ASTM D 638 and 639.

Oil resistance was evaluated by immersing the sample in ASTM No. 2 oil at 100° C. for 70 hours and then measuring a change (%) in width.

Thermal resistance tests were performed by placing the sample in an oven at 180° C. for one week and then measuring mechanical properties in the same manner as in the case of the measurement performed at ambient temperature.

Various standards were examined. In the mechanical properties, the following standards were used: tensile strength at ambient temperature: more than 2.5 kgf/cm²; elongation at ambient temperature: more than 100%, and oil resistance: a width change of less than 5%. Also in the mechanical properties after heating for evaluating thermal resistance, the same standards as the standards at ambient temperature were used.

Table 2 below shows the physical properties of the sample according to each of Examples and Comparative Examples.

TABLE 2

| | | | | | Comparative | | |
|---|---|---|---|---|---|---|---|
| | | Examples | | | Examples | | |
| Properties | Unit | 1 | 2 | 3 | 1 | 2 | 3 |
| Tensile strength at | Kgf/ | 3.1 | 3.6 | 2.9 | 4.3 | 3.9 | 3.7 |
| ambient temperature | cm² | | | | | | |
| Elongation at ambient | % | 285 | 133 | 556 | 111 | 103 | 109 |
| temperature | | | | | | | |
| Change in width after | % | 0.1 | 0.2 | 0.1 | 0.1 | 0.2 | 0.1 |
| immersion in oil | | | | | | | |
| Tensile strength after | Kgf/ | 3.9 | 4.8 | 2.9 | 5.9 | 5.2 | 5.0 |
| heating | cm² | | | | | | |
| Elongation after | % | 113 | 106 | 219 | 31 | 68 | 89 |
| heating | | | | | | | |

As shown in Table 2, in the test results, the mechanical properties at ambient temperature were higher than the standards in all Examples and Comparative Examples, but Examples showed a higher tensile strength but a significantly lower elongation than those of Comparative Examples.

Also, the samples were measured for mechanical properties after heating at 180° C. for one week and the measurement results are shown in Table 2. As shown in Table 2, Examples showed suitable properties in terms of both tensile strength and elongation, but Comparative Examples showed a great reduction in elongation. Regarding oil resistance, all the samples showed no problem.

Also, the tests were performed while changing the mixing ratio between the polyester-lactone copolymer resin and the polyester resin (Examples and Comparative Examples 1 and 2). In the test results, Examples which contains the copolymer resin in an amount of about 30% by weight based on the total weight of the resin composition showed results meeting the above standards.

It was found that if the content of the polymer resin was reduced below 30% by weight, a problem in thermal resistance would be caused, and particularly the elongation after heating would be very reduced. On the other hand, if the content of the copolymer resin was increased above 70%, tensile strength would be reduced below the standard.

Hence, it could be concluded that if the polyester-lactone copolymer resin and the polyester resin are mixed at a suitable ratio, preferable characteristics in terms of thermal resistance and physical properties will be achieved.

As described above, the inventive resin composition is generally based on the blend where the copolymer resin of the polyester component with the lactone resin is mixed with the polyester resin at a suitable ratio, to which various additives are added. Thus, the inventive resin composition is excellent in physical properties including thermal resistance, as compared to the prior resin composition comprising a blend of the polyester resins and other resins. Particularly, in the advanced resin composition according to the present invention, a change in the weight ratio between the polyester component and the lactone component in the polymer resin causes a change in physical properties, and on the basis of this change, the minimum value for the resin content can be established.

In addition, by virtue of suitable properties as described above, the inventive resin composition can be used in various applications by a processing method such as injection or extrusion. Particularly, the inventive resin can be applied to shapes, such as cable insulators or other electronic parts.

### INDUSTRIAL APPLICABILITY

Unlike the prior art based on a polyester resin composition, the inventive polyester resin composition is easily introduced with additives, has a significantly reduced possibility of hydrolysis and thus an improved thermal resistance, shows a wide elastic region, and is excellent in processability, impact resistance, thermal resistance and oil resistance. Particularly, by copolymerizing the polyester component with the lactone resin without simply mixing them and then blending the copolymer resin with the polyester resin, the effect of eliminating the reduction of thermal resistance and the deterioration of physical properties in long-term use is achieved, so that, upon application to cables and the like, the inventive resin composition will meet the desired characteristics of the cables.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A polyester resin composition comprising: (a) a first resin component containing a copolymer of a polyester component with a lactone component, and (b) a second resin component containing a polyester resin, wherein the content of the first resin component in the composition is 30-70% based on the total weight of the composition.

2. The polyester resin composition of claim 1, wherein the content of the first resin component is greater than that of the second resin component.

3. The polyester resin composition of claim 1, wherein the polyester component in the first resin component is polybutylene terephthalate, and the polyester resin in the second resin component is polybutylene terephthalate.

4. The polyester resin composition of claim 1, wherein the lactone is caprolactone.

5. The polyester resin composition of claim 1, further comprising magnesium hydroxide in an amount of 10-40% based on the total weight of the resin composition.

6. The polyester resin composition of claim 5, further comprising an antioxidant and polycarbodiimide in an amount of less than 10% based on the total weight of the resin composition.

7. A cable comprising a conductor and at least one insulation layer covered around the conductor,
wherein the insulation layer is made of a polyester resin composition as in claim 1.

8. The cable of claim 7, wherein the cable has two insulation layers consisting of an outer layer and an inner layer, wherein the outer or inner insulation layer is made of a polyester resin composition as in claim 1.
